(19) United States
(12) Patent Application Publication
(10) Pub. No.: US 2005/0127664 A1
(43) Pub. Date: Jun. 16, 2005

(54) Integral barbed fitting

(76) Inventors: Raymond M. Arth, Fairview Park, OH (US); Louzerne D. Cover, Avon Lake, OH (US)

Correspondence Address: WATTS HOFFMANN, CO. L.P.A., Suite 1750, 1100 Superior Avenue, Cleveland, OH, 44114, US

(21) Appl. No.: 10/994,888

(22) Filed: Nov. 22, 2004

Related U.S. Application Data
(60) Provisional application No. 60/524,544, filed on Nov. 24, 2003.

(51) Int. Cl. F16L 35/00

(52) U.S. Cl. 285/21.1; 285/179

(57) ABSTRACT

Disclosed is a coupling for a direct connection of supply tubing to a faucet assembly. The direct connection includes a barbed fitting that is integrally formed into the valve body to produce a one-piece unit. The integration of the fitting to the valve body is accomplished through either spin welding, sonic welding or hot-plate welding.

### RELATED APPLICATIONS

The present application is a non-provisional application claiming priority from provisional application Ser. No. 60/524,544 filed Nov. 24, 2003 and entitled INTEGRAL BARBED FITTING.

### FIELD OF THE INVENTION

The present invention relates to pipe fittings, specifically to a barbed fitting for use in a faucet assembly.

### BACKGROUND OF THE INVENTION

The use of plastic piping systems has grown in popularity in the areas of light commercial, residential, manufactured/modular housing, recreational vehicle and recreational marine industries. Plastic pipes and fittings are less expensive than their copper equivalents and can be installed more quickly without the need of professional plumbers. In addition, plastic offers superior resistance to corrosion and degradation under aggressive water conditions. The primary piping systems currently use rigid chlorinated polyvinyl chloride (CPVC) pipe and semi-flexible, cross-linked polyethylene (PEX) pipe.

Current faucet designs require that a connection fitting be installed on the end of a supply pipe or hose to produce a water tight, threaded seal to the faucet inlet shank. These connection fittings typically rely on an end loaded elastomeric material that can deteriorate over time resulting in supply line leaks. These connection fittings are also costly, increase installation time and require time to connect the fitting to the faucet. Additionally, many plumbing codes discourage the use of elastomeric seals for in-wall applications and frequently require the installation of an access panel if such fittings are used.

Therefore, there is a need in the art for secure, long lasting connection for water supply lines to a faucet.

### SUMMARY OF THE INVENTION

The present invention provides a new and improved coupling for direct connection of supply tubing to a faucet assembly. In the illustrated embodiment, a barbed fitting is integrated with a valve body. The barbed fitting includes standard male barb geometry at one end and a bonded spin weld nipple at another end. In a preferred embodiment, the bonding is accomplished by spin welding the barbed fitting directly to the valve body. By spin welding the barbed fitting to the valve body, the barbed fitting becomes an integral part of the valve body and not a detachable component. This process reduces overall component and labor costs for installation and manufacturing of a faucet assembly.

### BRIEF DESCRIPTION OF THE DRAWINGS

FIG. 1 is a perspective side view of a faucet assembly incorporating an embodiment of the present invention;

FIG. 2 is bottom view of the faucet assembly according to FIG. 1 taken along line 2-2;

FIG. 3 is a perspective view of a barb fitting according to the present invention and a supply end of a valve body;

FIG. 4 is a cross-sectional view of a valve body including a barbed fitting according to the present invention;

FIG. 5 is a cross-sectional view of a valve body according to FIG. 4 taken along line 5-5; and,

FIG. 6 is a cross-sectional view of a valve body including a straight barbed fitting according to the present invention.

### DETAILED DESCRIPTION

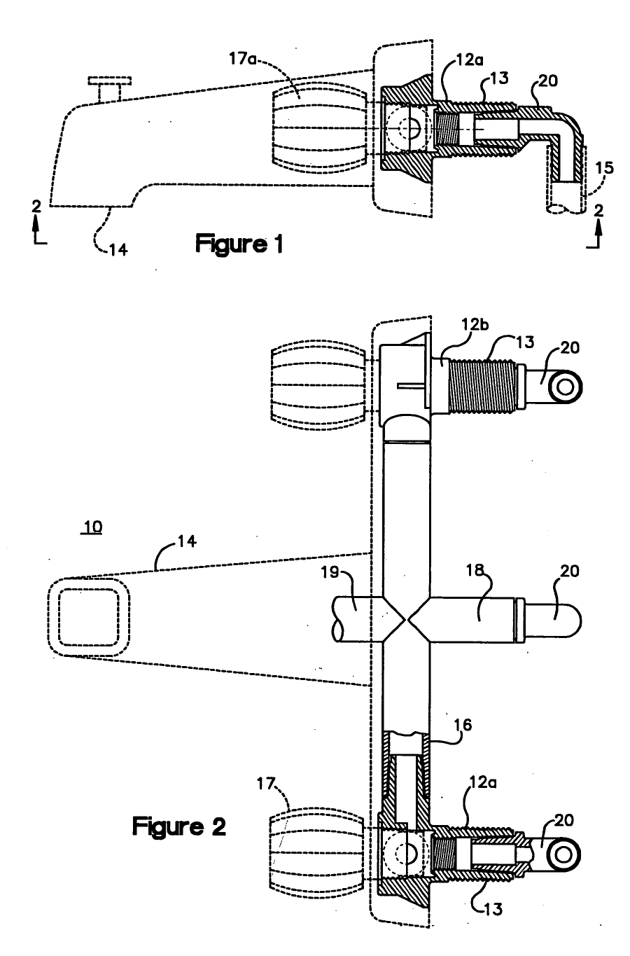

Turning now to the figures, FIGS. 1 and 2 show a faucet assembly 10 incorporating the present invention. In the disclosed embodiment, the faucet assembly 10 includes valve bodies 12a, 12b. Each valve body 12a, 12b has attached thereto a supply line 15 for supply both hot and cold water to the faucet assembly 10. Valve body 12a and 12b are in communication with each other via cross-pipe 16. Cross-pipe 16 includes two outlet connectors 18, 19. Outlet connector 18 supplies water to an overhead shower and outlet connector 19 supplies water to the tub spout 14. Valve bodies 12a and 12b are structurally similar in view of their orientation within the faucet assembly 10, therefore, for purposes of discussion, the valve bodies 12a, 12b will be generally referred to as valve body 12. Valve body 12 further includes a control knob 17 for controlling the amount of water allowed to enter the cross-pipe 16 through valve body 12. Valve body 12 includes threads 13 for securing the faucet assembly 10. Water is supplied to the valve body 12 through supply line 15 which is connected to the valve body 12 through use of barbed fitting 20. The barbed fitting 20 is integrated with the valve body by the method of the present invention as described in detail below, however, other bonding methods may be employed. The barbed fitting 20 allows for direct connection of PEX tubing to the valve body 12. In addition, the barbed fitting 20 as well as other faucet assembly components may be connected using the friction weld process. For example, the valve body 12 may be friction welded to cross-pipe 16 and a barbed fitting 20 can be friction welded to the outlet connector 18 if so desired. The components of the faucet assembly 10 are constructed from any plastic type material that can be spin-welded. Preferably, the material is a glass filled polypropylene. In the alternative, the components may be fabricated from brass or other metallic alloys appropriate for use in potable water supply lines.

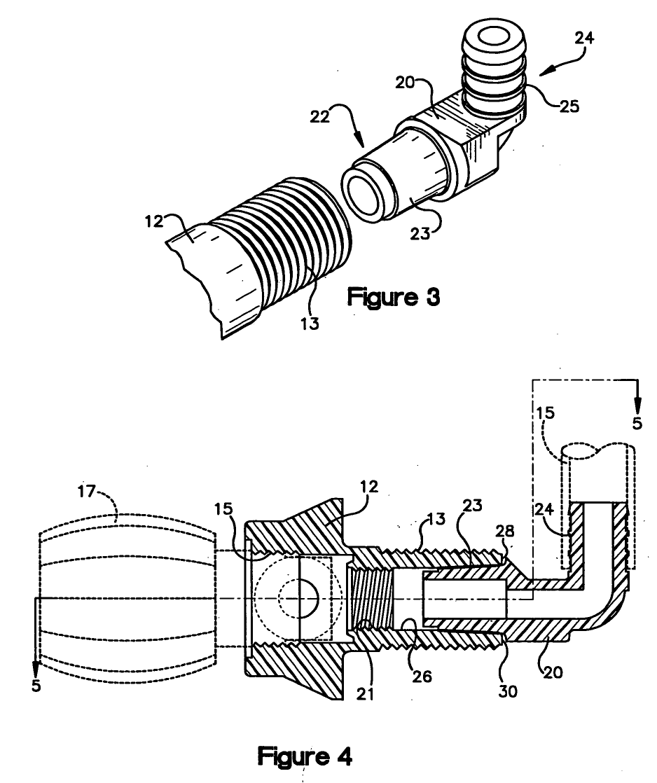

Turning now to FIG. 3, the barbed fitting 20 is shown prior to being friction welded to a valve body 12. The barbed fitting 20 includes a spin-weld nipple generally shown as reference character 22 that includes a male peripheral wall portion 23 and a male inlet end shown generally as reference character 24 having a plurality of barbs 25 (one shown). Although barbs are shown on the male inlet end 24, any other means that conforms to the standard specifications for attaching PEX tubing may be employed. The male peripheral wall portion 23 additionally acts as a bonding surface during the friction weld process. The barbed fitting 20 incorporates a 90° elbow (as shown) between the barbed end and the spin-weld nipple end. However, the barbed fitting may also be straight or angular depending on the desired plumbing. In the case where the 90° angle barb is employed, the design is such to permit a lock nut to slip over the fitting 20 and screw onto the shank threads 13 for securing the assembly 10 to a wall or deck.

Referring now to FIGS. 4-6, a closer view of a valve portion of the faucet assembly 10 is shown illustrating a valve body 12 including the barbed fitting 20. The valve body 12 includes threads 15 for securing a valve assembly and a control knob 17 to adjust the amount of water allowed to pass through the valve body 12 into the cross-pipe 16. Threads 21 act to secure a renewable seating element (not shown). In addition, the valve body 12 includes a hollow body portion defined by female internal peripheral wall 26 which additionally acts as a bonding surface. The female peripheral wall 26 extends from threads 16 to the butt end 28 of the valve body 12. The female peripheral wall 26 includes a taper from the threads 16 to the butt end 28. The diameter of the internal peripheral wall 26 increases as it extends from threads 13 to the butt end 28 of the valve body 12 thus creating a tapered geometry.

The hollow body portion defined by the female internal peripheral wall 26 is united with the barbed fitting 20 at a joint indicated generally by reference character 30. The joint being formed using the process of the present invention. The peripheral male wall portion 23 of the barbed fitting 20 mates with the female peripheral wall portion 26 such that an integral bond is formed between the male wall portion 23 and the female wall portion 26. It must be understood that the male and female wall portions 23, 26 can be reversed, i.e., the male wall portion 23 can be made as part of the valve body 12.

In the preferred process of the present invention, the valve body 12 is positioned or chucked into a spinning apparatus which is operative to produce a relative rotation between the valve body 12 and the barbed fitting 20. The male peripheral wall portion 23 of the barbed fitting 20 is inserted into the female peripheral wall portion 26 of the valve body 12 until such surfaces are in contact with each other. As noted, during the welding of the barbed fitting 20 to the valve body 12, the male and female peripheral wall portions 23, 26 are used as bonding surfaces to form the weld.

To effect the weld, the barbed fitting 20 is rotated such to a speed which generates enough friction to melt the respective materials. Preferably, the barbed fitting 20 is rotated at a speed of about 1,500 rpm. It should be noted that either the valve body 12 or the barbed fitting 20 can be held stationary while the mating portion is spun. During the spinning process, the vale body 12 and barbed fitting 20 are brought together under pressure. Preferably, the pressure applied is about 80 psi. Once enough heat is generated during the spinning process to friction weld the parts together, the spinning is stopped such that the parts are aligned in a predetermined position. Such predetermined position is preferably one that the orientation of the angled fittings is correct for standard plumbing. The machine used to perform the process of the present invention is one that can friction weld the parts as described. Once such machine is a custom made Phoenix Spin Welder. However, any machine that is within the knowledge of one of ordinary skill in the art will suffice. Once the weld is formed and the spinning subsides, the parts are allowed to cool, thus forming an integral bond between the male peripheral wall portion of the barbed fitting 20 and the female peripheral wall portion of the valve body 12.

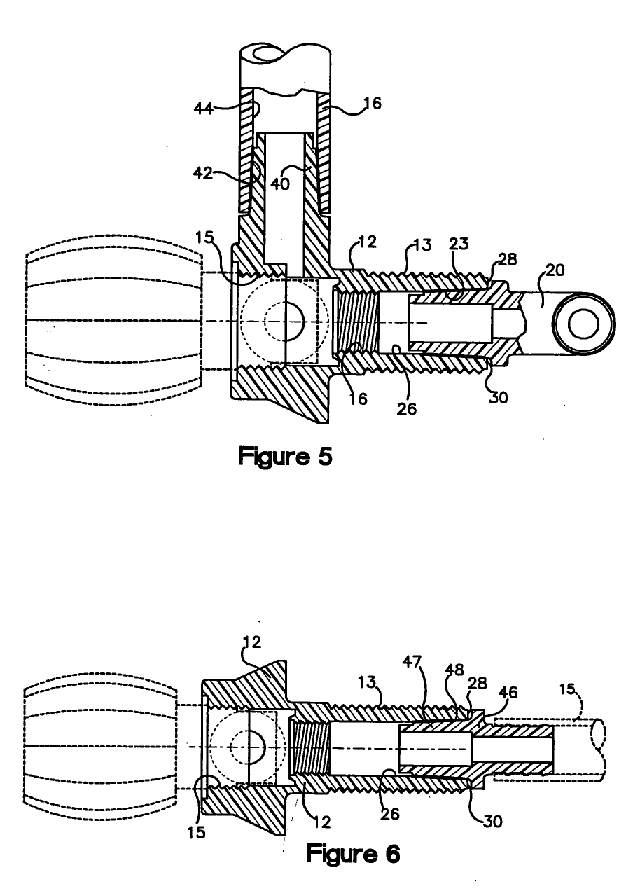

FIG. 5 shows the valve body 12 with an integrated cross pipe 16 and barbed fitting 20. The valve body 12 further includes a male portion 40 which is used to connect the cross pipe 16 to the valve body 12. The male portion 40 is inserted into the cross pipe 16. Using the friction weld process described above, a weld is formed between the outer peripheral wall 42 of the male portion 40 and the internal wall 44 of the cross pipe. Preferably, during the process the cross pipe 16 is held stationary while the valve body is rotated. Even though such method is preferred, the valve body 12 can be held stationary while the cross pipe 16 is rotated depending on the configuration of the piping and ease of operation to perform the process.

FIG. 6 shows the valve body 12 integrally bonding a straight barbed fitting 46. This fitting is friction welded using the process of the present invention. The fitting 46 possess all of the components of the elbow fitting except it has a straight configuration rather than including a 90° elbow. Even though only an elbow fitting and straight fitting are shown, the barbed fitting can be designed to include any angle or bend depending on the desired plumbing. Like the elbow fitting, the straight fitting 46 includes a male portion 47 including an outer peripheral wall surface 48. The peripheral wall surface 48 contacts the internal female peripheral wall portion 26 of the valve body 12 to form a friction weld bond by way of the process described above.

Although the components of the faucet assembly 10 are described as being spin-welded together, in an alternative embodiment, the invention also contemplates integrating the faucet assembly 10 parts together through other means as well. Such other means include sonic welding, hot plate welding and one-piece fabrication. Sonic welding and hot plate welding are processes that are common and known to those of ordinary skill in the art. These alternate methods of fabrication preserve the simplicity and flexibility of the preferred embodiment.

In the case of one-piece fabrication, the barbed fitting may be incorporated into the valve body by casting a valve body (where the faucet assembly is made of metal alloy components) including a barbed fitting. In the case of thermoplastic material, the barbed fitting can be integrated with the valve body through molding or any other means as known to those of ordinary skill in the art of plastics.

In any of the above embodiments, the barbed fitting becomes in integral part of the faucet shank. This allows supply lines to be connected directly to the faucet without the need for any transitional couplings.

Although the barbed fitting is shown is connection with a tub/shower divettet, the fitting 20 may be employed in any wall mount or ledge mount, kitchen or lavatory faucet (either at a 90° angle, straight or some angular variation thereof) designs or any other plumbing connection as apparent to those of ordinary skill in the art in view of this disclosure.

While the exemplary embodiments of the invention have been described with a degree of particularity, it is the intent that the present invention include all modifications and alterations from the disclosed design falling with the spirit or scope of the appended claims.

1. A pipe fitting comprising:
a tubular body member comprising a barbed body portion at one distal end and comprising a spin weld nipple portion at a second distal end.

2. The apparatus of claim 1 wherein said tubular body is linear.

3. The apparatus of claim 1 wherein the tubular body includes at least one curve along its longitudinal axis.

4. The apparatus of claim 3 wherein said curve is about 90°.

5. The apparatus of claim 1 wherein said fitting is made from plastic.

6. An integrated valve body for use in a piping system comprising:
a first coupling portion including a connection for a valve; and
a second coupling portion integrally formed to the distal end of first coupling portion opposite said valve wherein said second coupling portion includes barbs for connection with a supply line.

7. The apparatus of claim 6 wherein said second coupling portion is integrally formed to said first coupling portion by spin welding.

8. The apparatus of claim 6 wherein said second coupling portion is integrally formed to said first coupling portion by bonding.

9. The apparatus of claim 8 wherein said bonding is accomplished through sonic welding.

10. The apparatus of claim 8 wherein said bonding includes hot-plate welding.

11. The apparatus of claim 6 wherein said first coupling portion and said second coupling portion are fabricated as one piece.

12. The apparatus of claim 6 wherein the first coupling portion and said second coupling portion are fabricated as one piece from a suitable metal for use in potable water systems.

13. The apparatus of claim 12 wherein said metal is brass.

14. The apparatus of claim 6 wherein said second coupling portion is linear.

15. The apparatus of claim 6 wherein second coupling portion includes at least one curve along its longitudinal axis.

16. The apparatus of claim 15 wherein said curve is at least 90°.

17. The apparatus of claim 6 wherein the first coupling portion includes threads and the second coupling portion includes a curve along its longitudinal axis wherein a locking nut is fitted over the curve portion of the second coupling member and threaded onto the threads of the first coupling portion for securing the valve body.

18. A method for making a plumbing fixture having an integrated barbed fitting comprising:
positioning a valve body in a stationary position;
placing the coupling end of a barbed fitting into the valve body such that the internal surface of the valve body contacts the outside portion of the coupling end; and
integrating the outside portion of the coupling end of the barbed fitting with the internal surface of the valve body.

19. The method of claim 18 wherein the integration comprises the following steps:
spinning the barbed fitting for a length of time and under such pressure sufficient to generate an amount of heat needed to fiction weld the barbed fitting into the valve body; and
stopping the spin weld process such that the barbed fitting is welded at a desired position.

20. The method of claim 18 wherein the integration includes sonic welding.

21. The method of claim 18 wherein the integration includes hot plate welding.
